(19) United States
(12) Patent Application Publication
(10) Pub. No.: US 2026/0324644 A1
(43) Pub. Date: Oct. 22, 2026

(54) HERBICIDE COMPOSITION AND A METHOD FOR BURNDOWN APPLICATION

(71) Applicants: UPL Mauritius Limited, Port Louis (MU); UPL EUROPE LTD, Cheshire (GB)

(72) Inventors: Giuvan Lenz, Pereiras (BR); Ganesh Rao, Mumbai (IN)

(21) Appl. No.: 19/111,218

(22) PCT Filed: Sep. 13, 2023
(86) PCT No.: PCT/GB2023/052367

§ 371 Date: Mar. 12, 2025

(30) Foreign Application Priority Data
Sep. 14, 2022 (IN) 202211052518

(51) Int. Cl. A01N 57/20; A01P 13/00

(52) U.S. Cl. CPC A01N 57/20; A01P 13/00

(57) ABSTRACT

The present disclosure relates to a herbicidal composition comprising L-glufosinate, salts, esters, or combinations thereof. More particularly, the present herbicidal composition is particularly useful for preplant burndown in absence of crops. The present disclosure also provides a method for controlling undesired vegetation/weeds in burndown application using present herbicidal composition.

### FIELD OF THE DISCLOSURE

The present disclosure relates to a herbicidal composition comprising L-glufosinate, salts, esters, or combinations thereof. More particularly, the present herbicidal composition is particularly useful for preplant burndown. The present disclosure also provides a method for controlling undesired vegetation in burndown application using present herbicidal composition.

### BACKGROUND OF THE DISCLOSURE

Herbicides are pesticides useful for killing or controlling unwanted plants or weeds. Generally, there are two kinds of herbicides—selective and non-selective herbicides. Selective herbicides kill certain target weeds while leaving the desired crop relatively unharmed, while non-selective herbicides kill both the weeds and crops. The weeds can reduce crop yields by competing for water, sunlight and nutrients. Therefore, profitable crop production depends on effective weed control.

A complete removal of weeds from the soil with herbicides before planting of the crops or in absence of any crops is referred to as “burndown”. Weeds present at planting will generally grow much quicker than crop plants and thus compete very early in the growing season thereby damaging the crop plants and reducing crop yield. Therefore, it is desirable to plant the crop in a weed-free seed bed or to assure that essentially no weeds or unwanted plants are present when the crop is planted or before emergence of the crop. The herbicides used in the pre-emergence stage of crop provide potential control of the weeds without the crop-weed competition in the initial stages of development, thereby increasing the yield of the crop. Early burndown herbicide applications provide an opportunity to manage winter annual and other early emerging weeds before they become difficult to control. In fact, preplant burndown tank mixtures can remove early weed infestations and provide broad spectrum foliar and residual weed control. Dicamba or 2,4-D is generally used in burndown tank mixtures with glyphosate for post-emergence control of tough broadleaf weeds. Therefore, including a herbicide with residual activity in the burndown tank mixture can help to extend early-season weed control and reduce in-season weed growth.

The inventors of the present disclosure provide a herbicidal composition and a method of use of the herbicidal composition for burndown application, which is associated to the use of pre-emergent herbicides for management of weeds in the crops.

Glufosinate (also known as phosphinothricin; DL-homoalanin-4-yl(methyl)phosphinic acid) is a racemic phosphinico amino acid. Its ammonium salt (glufosinate-ammonium) is widely used as a non-selective herbicide and is an active ingredient of many commercial herbicide formulations. The herbicidally active L-isomer of glufosinate is a structural analogue of glutamate and, therefore, is a competitive inhibitor of the enzyme glutamine synthetase (GS) of bacteria and plants. The D-isomer is not a GS inhibitor and is not herbicidally active. Glufosinate is a contact herbicide and is taken up by the plant primarily through the leaves. There is no uptake from the soil through the roots, presumably because of the rapid degradation of glufosinate by soil micro-organisms. Glufosinate has a wide spectrum of activity encompassing monocotyledonous and dicotyledonous species.

Glutamine synthetase (GS) is one of the most abundant enzymes in plant cells. It is essential for nitrogen metabolism because it catalyses the conversion of glutamate and ammonium into glutamine. The essential role of GS in plants makes the enzyme an interesting target for herbicides. Inhibition of GS has catastrophic consequences to plant metabolism, leading to a massive accumulation of reactive oxygen species (ROS) due to impairment of photosynthesis and photorespiration. Several experimental inhibitors have been discovered but only glufosinate has been developed as a commercial herbicide. Glufosinate is a racemic mixture of D- and L-phosphinothricin but only the L-isomer inhibits GS. In addition to showing prominent herbicidal effects on a wide spectrum of weeds, L-isomer of glufosinate can be used by micro-organisms as a source of nitrogen and is subject to microbial degradation. Fast dissipation of the DL-racemic mixture was found in all soils investigated under laboratory, as well as field conditions.

In today's crop production systems, starting off with a good burndown program is a must as it helps to achieve maximum initial crop growth and reduce weed interference during early stages of the crop cycle. Since the weed-crop competition is critical during the early stages of crop cycle, the weed interference at early stage has a direct impact on the yield of the crop. The present disclosure, thus, provides a herbicidal composition and a method for controlling broadleaf weeds and grassy weeds, and, more particularly, for early (pre-emergence) preplant burndown application to prepare a field for planting crops, such as cotton, corn, soybean, etc. The herbicidal composition of the present disclosure comprises L-glufosinate, salts, esters, or combinations thereof.

### OBJECTIVES OF THE DISCLOSURE

It is a primary objective of the present invention to provide a herbicidal composition for efficient weed control, weed suppression and eradication for a wide spectrum of weeds, both dicotyledonous and monocotyledonous, broadleaf, and grassy weeds.

It is another objective of the present invention to provide a herbicidal composition comprising L-glufosinate, salts, esters, or combinations thereof for selective and non-selective weed control.

It is another objective of the present invention to provide a herbicidal composition comprising L-glufosinate, salts, esters, or combinations thereof for an efficient burn-down program.

It is another objective of the present invention to provide a herbicidal composition comprising L-glufosinate, salts, esters, or combinations thereof by burndown in absence of crops.

It is yet another objective of the present invention to provide an herbicidal composition, which is safe to use, effective and can be applied at pre-emergence stage.

### SUMMARY OF THE DISCLOSURE

In an aspect, the present disclosure provides a herbicidal composition comprising L-glufosinate, salts, esters, or combinations thereof for effective burndown prior to planting a crop.

In an aspect, the present disclosure provides effective preplant burndown herbicidal composition comprising L-glufosinate, salts, esters, or combinations thereof or in combination with reduced amounts of an additional herbicide for use in burndown program.

In an aspect, the present disclosure provides a method for controlling undesirable vegetation in burndown program, in vegetable fields, perennial crop fields, in industrial vegetation managing and forestry, and also in lawn and turf, in absence of any crops.

### DETAILED DESCRIPTION OF THE DISCLOSURE

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about” and is meant to encompass variations of ±10%, ±5%, ±1%, ±0.5%, or even ±0.1% of the specified value as well as the specified value.

Unless otherwise defined, all technical and scientific terms used herein have the same meaning as commonly understood by one of ordinary skill in the art to which this disclosure pertains. In the case of conflict, the present document, including definitions will control.

It must be noted that, as used in this specification, the singular forms “a”, “an” and “the” include plural referents unless the content clearly dictates otherwise. The terms “preferred” and “preferably” refer to embodiments of the invention that may afford certain benefits, under certain circumstances.

The expression of various quantities in terms of “%” or “% w/w” means the percentage by weight of the total solution or composition unless otherwise specified.

The term “herbicide” as used herein denotes a compound which controls or modifies the growth of undesired weeds.

The term “herbicidally effective amount” indicates the quantity of such a compound or combination of such compounds which is capable of controlling or modifying effect on the growth of harmful plants. Controlling effects include all deviation from natural development, for example: killing, retardation, leaf burn, albinism, dwarfing etc. The term “plants” refer to all physical parts of a plant, including seeds, seedlings, saplings, roots, tubers, stems, stalks, foliage and fruits.

The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus. The said locus could be a weed, an area adjacent to the weed, soil adapted to support growth of the weed, a root of the weed and/or foliage of the weed.

As used herein, the terms “undesirable vegetation”, “undesirable species”, “undesirable plants”, “harmful plants”, “undesirable weeds”, “harmful weeds” or “weed” are synonyms.

The terms “g a.i./L” as used herein denotes the concentration of the respective active ingredient in “grams” present “per litre” of the composition. The terms “g a.i./L”, “g a.i./L” and “g/L” may be used interchangeably.

The terms “g a.i./ha” as used herein denotes the concentration of the respective active ingredient in “grams” applied “per hectare” of the crop field. The terms “g ai/ha”, “g a.i./ha” and “g/ha” may be used interchangeably.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or plant growth promoting agents or adjuvants or excipients not specifically recited therein.

Glufosinate (also known as phosphinothricin; DL-homoalanin-4-yl(methyl)phosphinic acid) is a racemic phosphinico amino acid (Hoerlein, G. 1994; Glufosinate (Phosphinothricin), a natural amino acid with unexpected herbicidal properties. Rev. of Environmental Contamination and Toxicology 138, 73-145). Its ammonium salt (glufosinate-ammonium) is widely used as a non-selective herbicide. The L-isomer of glufosinate is a structural analogue of glutamate and, therefore, is a competitive inhibitor of the enzyme glutamine synthetase (GS) of bacteria and plants (Bayer et al, 1972, Phosphinothricin and phosphinothricyl-alanyl-alanin. Helv. Chim. Acta 55, 224-239; Leason et al., 1982, Inhibition of pea leaf glutamine synthetase by methioninsulfoximine, Phosphinothricin and other glutamate analogs. J. Phytochem. 21, 855-857). The chemical structures of D-glufosinate and L-glufosinate are represented as below.

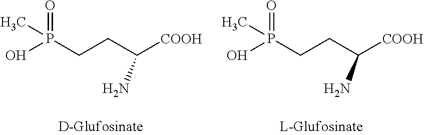

As used herein, the term “glufosinate” refers to any molecule which is a racemic phosphinico amino acid. The term also includes salts, forms such as solvates, hydrates, anhydrous form, crystalline form, polymorph forms, pseudo polymorph forms, amorphous form or mixture thereof, and sodium, potassium or ammonium salts. The salts of glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)+ salt, and —NH₂(CH₃)(C₂H₄OH)⁺ salt are included in the definition. The agronomically acceptable salts include glufosinate-ammonium, glufosinate-sodium, and glufosinate-potassium.

As used herein, the term “L-glufosinate” refers to the L-isomer of glufosinate, a salt and an ester thereof. It is also known as phosphinothricin or (S)-2-amino-4-(hydroxy(methyl)phosphonoyl)butanoic acid. The term can generically refer to any form of L-glufosinate such as solvates, hydrates, esters, anhydrous form, polymorph forms, pseudo polymorph forms, amorphous form or mixture thereof, and sodium, potassium or ammonium salts. The salts of L-glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺salt, —NH(CH₃)₂(C₂H₄OH)⁺ salt, and —NH₂(CH₃)(C₂H₄OH)⁺ salt are included in the definition. The agronomically acceptable salts include L-glufosinate-ammonium, L-glufosinate-sodium, and L-glufosinate-potassium. The term may also refer to an isomeric (racemic) mixture of L-glufosinate, D-glufosinate and salts thereof, wherein the content of L-glufosinate in the mixture is about 70% or greater, preferably about 80% or greater and more preferably about 90% or greater. Typically, the ratio of L-glufosinate: D-glufosinate can be in the range from about 90:10 to about 99.9:0.1, preferably from about 95:5 to about 99.9:0.1.

According to the present disclosure there is provided a herbicidal composition and a method of application of the said composition, which is useful for efficient control of undesired vegetation, particularly grasses and broadleaf weeds in a burndown program. Moreover, the persistence of the herbicidal activity of the composition of the present disclosure is sufficiently long in order to achieve control of the weeds over a sufficient long period thus allowing a more flexible application. Further, it is needed to use burndown herbicide programs with more than one effective site of action to delay the development of resistant weeds and provide the best control. The inventors of the present disclosure have further provided a herbicidal combination for efficient control of undesired vegetation in a burndown program in absence of crops.

It is an advantage of the present disclosure that the preplant burndown herbicide composition provides from about 70% to about 100% burndown, including grassy weeds and broadleaf weeds. Moreover, the properties and advantages mentioned are required in practical weed control in order to keep agricultural crops free of unwanted competing plants, and thus to qualitatively and quantitatively ensure and/or increase the yields.

The present disclosure, therefore, in an embodiment, provides, a herbicidal composition for controlling weeds at a locus thereof, by burndown in absence of a crop, the composition comprising:
(a) L-glufosinate, salts, esters, or combinations thereof; and
(b) at least one agrochemically acceptable excipient.

In an embodiment, the salt comprises an inorganic salt of L-glufosinate.

In an embodiment, the inorganic salt of L-glufosinate is selected from the group comprising L-glufosinate ammonium, L-glufosinate sodium, L-glufosinate potassium, or combinations thereof. The inorganic salts of L-glufosinate can be selected from the group comprising monosodium salt, disodium salt, monopotassium salt, dipotassium salt, calcium salt, ammonium salt, —NH₃(CH₃)+ salt, —NH₂(CH₃)₂+ salt, —NH(CH₃)₃+ salt, —NH(CH₃)₂(C₂H₄OH)+ salt, and —NH₂(CH₃)(C₂H₄OH)+ salt. The choice of the specific salt form is not particularly limiting.

In an embodiment, the inorganic salt of L-glufosinate is L-glufosinate ammonium.

In an embodiment, the inorganic salt of L-glufosinate is L-glufosinate sodium.

In an embodiment, the inorganic salt of L-glufosinate is L-glufosinate potassium.

In an embodiment, the herbicidal composition for burndown application in absence of a crop comprises:
(a) L-glufosinate ammonium; and
(b) at least one agrochemically acceptable excipient.

In an embodiment, the total amount of L-glufosinate, salts, esters, or combinations thereof in the composition may typically be in the range of about 0.1% to about 99% by weight of total weight of the composition.

In an embodiment, the L-glufosinate, salts, esters, or combinations thereof is used in an amount in the range of from about 100 g a.i./L to about 1000 g a.i./L. In an embodiment, the L-glufosinate, salts, esters, or combinations thereof is used in an amount from about 100 g a.i./L to about 400 g a.i./L. In an embodiment, the L-glufosinate, salts, esters, or combinations thereof is used in an amount in the range of from about 150 g a.i./L to about 350 g a.i./L. In an embodiment, the L-glufosinate, salts, esters, or combinations thereof is used in an amount in the range of from about 250 g a.i./L to about 300 g a.i./L.

In one preferred embodiment, the L-glufosinate, salts, esters, or combinations thereof is present in an amount of about 280 g a.i./L.

In one preferred embodiment, the L-glufosinate, salts, esters, or combinations thereof is present in an amount of about 200 g a.i./L.

In one preferred embodiment, the L-glufosinate, salts, esters, or combinations thereof is present in an amount of about 150 g a.i./L.

In another aspect, the present disclosure provides a herbicidal combination for controlling weeds at a locus thereof, by burndown in absence of a crop, the combination comprising:
(a) L-glufosinate, salts, esters, or combinations thereof; and
(b) at least one additional herbicide.

In another embodiment, a herbicidal composition for controlling weeds at a locus thereof, by burndown in absence of a crop, the composition comprising:
(a) L-glufosinate, salts, esters, or combinations thereof, and
(b) at least one agrochemically acceptable excipient.

In another embodiment, the composition further comprises at least one additional herbicide.

In another aspect the present disclosure provides, a herbicidal composition for burndown application in absence of a crop, the composition comprising:
(a) L-glufosinate, salts, esters, or combinations thereof;
(b) at least one additional herbicide; and
(c) at least one agrochemically acceptable excipient.

In an embodiment, the present disclosure provides a herbicidal composition for burndown, the composition comprising a combination comprising L-glufosinate, salts, esters, or combinations thereof and at least one additional herbicide, wherein a weight ratio of L-glufosinate, salts, esters, or combinations thereof and the additional herbicide ranges from about 1:100 to about 100:1. In another embodiment, the weight ratio of L-glufosinate, salts, esters, or combinations thereof and the additional herbicide ranges from about 1:75 to about 75:1. In still another embodiment, the weight ratio of L-glufosinate, salts, esters, or combinations thereof and the additional herbicide is in the range from about 1:50 to about 50:1. In still another embodiment, the weight ratio of L-glufosinate, salts, esters, or combinations thereof and the additional herbicide is in the range from about 1:25 to about 25:1. In still another embodiment, the weight ratio of L-glufosinate, salts, esters, or combinations thereof and the additional herbicide is in the range from about 1:10 to about 10:1. In a preferred embodiment, the weight ratio of L-glufosinate, salts, esters, or combinations thereof and the additional herbicide is in the range from about 1:5 to about 5:1.

In an embodiment, the additional herbicide which can be combined with L-glufosinate, salts, esters, or combinations thereof for burndown application is selected from the group comprising 2,4-D, 2,4-D choline, acetochlor, aclonifen, amicarbazone, halauxifen, halauxifen-methyl, florpyrauxifen, amidosulfuron, aminocyclopyrachlor, aminopyralid, aminotriazole, ammonium thiocyanate, anilofos, asulam, azimsulfnron, atrazine, beflubutamid, benazolin, benfuresate, bensulfuron-methyl, bentazon-sodium, benzofenap, bifenox, bispyribacsodium, bromobutide, bromacil, bromoxynil, butachlor, butafenacil, butralin, butroxydim, carbetamide, cafenstrole, carfentrazone, carfentrazone-ethyl, chlormequat, clopyralid, chlorsulfuron, chlortoluron, cinidon-ethyl, clethodim, clodinafop-propargyl, clomeprop, clomazone, cloransulam-methyl, cyanazine, cyclopyrimorate, cyclosulfamuron, cycloxydim, cyhalofop-butyl, daimuron, dicamba, dichlobenil, dichlorprop-P, diclofop-methyl, diclosulam, diflufenican, diflufenzopyr, dimefuron, dimethachlor, diquat, diuron, 5-ethyl dipropylcarbamothioate (EPTC), esprocarb, ethoxysulfuron, etobenzanid, fenoxaprop, fenoxaprop-ethyl, fenoxapropethyl+isoxadifen-ethyl, fenoxaprop-P-ethyl, fenoxasulfone, fenquinotrione, fentrazamide, flazasulfuron, florasulam, fluazifop, fluazifop-P-butyl, flucarbazone, flucarbazone-sodium, flucetosulfuron, flufenacet, flumetsulam, flumioxazin, flupyrsulfuron, flurochloridone, fluroxypyr, fluroxypyr-meptyl, flurtamone, glufosinate, glufosinate-ammonium, glyphosate, halosulfuron-methyl, haloxyfop-methyl, haloxyfop-R-methyl, hexazinone, imazamethabenz, imazamox, imazapic, imazapyr, imazaquin, imazethapyr, imazosulfuron, indanofan, indaziflam, iodosulfuron, iodosulfuron-ethyl-sodium, iofensulfuron, ioxynil, ipfencarbazone, isoproturon, isoxaben, isoxaflutole, lactofen, linuron, MCPA, MCPB, mecoprop-P, mefenacet, mesosulfuron, mesosulfuron-ethyl sodium, mesotrione, metamifop, metazochlor, metazosulfuron, metosulam, metribuzin, metsulfuron, metsulfuronmethyl, molinate, napropamide, napropamide-M, orfurazon, orthosulfamuron, oryzalin, oxadiargyl, oxadiazon, oxazichlomefone, oxyfluorfen, paraquat, pendimethalin, penoxsulam, pentoxazone, pethoxamid, picloram, picolinafen, pinoxaden, pretilachlor, primisulfuron, profluazol, profoxydim, propanil, propaquizafop, propyrisulfuron, propoxycarbazone, propyzamide, prosulfocarb, prosulfuron, pyraclonil, pyraflufen-ethyl, pyrasulfotole, pyrazosulfuron-ethyl, pyrazolynate, pyribenzoxim, pyributicarb, pyridate, pyriftalid, pyrimisulfan, pyroxsulam, pyroxasulfone, quinclorac, quinmerac, quizalofop-ethyl-D, quizalofop-P-ethyl, quizalofop-P-tefuryl, rimsulfuron, sethoxydim, simazine, sulcotrione, sulfentrazone, sulfometuron, sulfosate, sulfosulfuron, tebuthiuron, tefuryltrione, tepraloxidim, terbacil, terbuthylazine, terbutryn, thenylchlor, thiazopyr, thifensulfuron, thifensulfuron-methyl, thiobencarb, topramezone, tralkoxydim, triafamone, triasulfuron, tribenuron, tribenuron-methyl, triafamone, triclopyr, trifluralin, and agriculturally acceptable salts, esters, mixtures, or combinations thereof.

In an embodiment, the present combinations/compositions can further comprise one or more co-herbicides. The examples of co-herbicides that can be combined with present herbicidal combinations include, but are not limited to, tetflupyrolimet, dioxopyritrione, rimisoxafen, benquitrione, bipyrazone, cypyrafluone, fenpyrazone, tripyrasulfone, anisiflupurin, beflubutamid, bixlozone, cyclopyranil, dimesulfazet, epyrifenacil, topramezone, orthosulfamuron, pinoxaden, metamifop, pyrimisulfan, tembotrione, thiencarbazone methyl, flucetosulfuron, aminopyralid, pyrasulfotole, saflufenacil, pyroxsulam, pyroxasulfone, pyraclonil, indaziflam, fenquinotrione, tiafenacil, cinmethylin, lancotrione-sodium, bixlozone, trifludimoxazin, cyclopyrimorate, methiozolin, aminocyclopyrachlor, metazosulfuron, ipfencarbazone, fenoxasulfone, bicyclopyrone, triafamone, halauxifen methyl, tolpyralate, or combinations thereof.

In an aspect, the present disclosure provides a preplant burndown herbicidal composition comprising L-glufosinate, salts, esters, or combinations thereof and at least one agrochemically acceptable excipient.

In another aspect, the present disclosure provides a preplant burndown herbicidal composition comprising L-glufosinate, salts, esters, or combinations thereof, at least one additional herbicide and at least one agrochemically acceptable excipient.

In an aspect, the present disclosure provides a preplant burndown herbicidal composition comprising L-glufosinate, salts, esters, or combinations thereof in a concentration ranging from about 1% w/w to about 99% w/w of the total composition.

In an embodiment, the preplant burndown herbicidal composition further comprises at least one agrochemically acceptable excipient/carrier(s). The agrochemically acceptable excipient/carrier(s) can be used in an amount from 1% w/w to about 99% w/w of the total composition.

In an embodiment, the agrochemically acceptable excipients/carriers/additives comprise at least one co-solvent(s), surfactant(s), water, colorant(s), dispersant(s), emulsifier(s), thickener(s), antifreeze agent(s), biocide(s), anti-foam agent(s), stabilizer(s), wetting agent(s), or combinations thereof.

In an embodiment, the surfactant(s) may be selected from non-ionic, anionic, cationic surfactants, or combinations thereof.

In an embodiment, the examples of non-ionic surfactants comprise polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol, or combinations thereof.

In an embodiment, the examples of anionic surfactants comprise alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates, or combinations thereof.

In an embodiment, the cationic surfactants comprise alkanol amides of C₈-C₁₅ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates, or combinations thereof.

In an embodiment, the emulsifier(s) which can be advantageously employed herein can be readily determined by those skilled in the art and comprise various non-ionic, anionic, cationic and amphoteric emulsifiers, or a blend of two or more emulsifiers. Examples of nonionic emulsifiers useful in preparing emulsifiable concentrates, for example, include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts.

Anionic emulsifiers include the oil-soluble salts (e.g., calcium) of alkylaryl sulfonic acids, oil-soluble salts or sulfated polyglycol ethers and appropriate salts of phosphated polyglycol ether, or combinations thereof.

In an embodiment, the colorant(s) comprise iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum, zinc, or combinations thereof.

Another embodiment involves addition of a thickener or binder which may be selected from the group comprising molasses, granulated sugar, alginates, karaya gum, jaguar gum, tragacanth gum, polysaccharide gum, mucilage, xanthan gum, or combinations thereof. In another embodiment, the binder may be selected from the group comprising silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols, or combinations thereof.

In another embodiment, an antifreeze agent(s) added to the composition may be alcohols selected from the group comprising ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol, or combinations thereof.

According to an embodiment, the biocide(s) or preservative(s) comprise benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl, or combinations thereof.

According to an embodiment, the antifoam agent(s) comprise polydimethoxysiloxane, polydimethylsiloxane, alkyl poly acrylates, castor oil, fatty acids, fatty acid esters, fatty acid sulfates, fatty alcohols, fatty alcohol esters, fatty alcohol sulfates, olive oil, mono and di glycerides, paraffin oil, paraffin wax, polypropylene glycol, silicone oil, vegetable and animal fats, sulfates of vegetable and animal fat, vegetable and animal oils, sulfates of vegetable and animal oils, vegetable and animal waxes, sulfates of vegetable and animal waxes, agents based on silicon or magnesium stearate, or combinations thereof.

According to an embodiment, the agrochemical formulation may also comprise one or more antioxidants. Preferably, the agrochemical formulation comprises an antioxidant. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., a-carotene, 0-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, y-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA (Ethylenediaminetetraacetic acid), EGTA (Ethylenebis(oxyethylenenitrilo)tetraacetic acid), phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to an embodiment, the mixtures of the aforementioned antioxidants are possible.

According to an embodiment, the examples of solvents are water, aromatic solvents (for example xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones, N-Methyl-2-pyrrolidone (NMP), N-Ethyl-2 pyrrolidone (NEP), N-Octyl-2-pyrrolidone (NOP), acetates (glycol diacetate), glycols, fatty acid dimethylamides, fatty acids and fatty acid esters, isophorone and dimethylsulfoxide, or combinations thereof.

According to an embodiment, solvent mixtures may also be used.

According to an embodiment, exemplary surfactants comprise alkali metal, alkaline earth metal and ammonium salts of lignosulfonic acid, naphthalene sulfonates, phenolsulfonic acid, dibutylnaphthalenesulfonic acid, alkylarylsulfonates, alkyl sulfates, alkyl sulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalene sulfonic acid with phenol and formaldehyde, polyoxyethylene octyl phenol ethers, ethoxylated isooctylphenol, octyl phenol, nonylphenol, alkylphenol polyglycol ethers, tributyl phenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose, or combinations thereof.

According to an embodiment, examples of carriers comprise mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, urea, and products of vegetable origin, such as cereal meal, tree bark meal, wood meal and nutshell meal, cellulose powders, polyvinylpyrrolidone and other solid carriers, or combinations thereof.

In another aspect, present compositions may further comprise at least safener.

In an embodiment the safener can be selected from the group comprising isoxadifen-ethyl, cloquintocet-mexyl, mefenpyr-diethyl, naphthalic anhydride, oxabetrinil, benzenesulfonamide, N-(aminocarbonyl)-2-chlorobenzene sulfonamide (2-CBSU), daimuron, dichloroacetamide, dicyclonon, fenchlorazole-ethyl, fenclorim, fluxofenim, Dichloroacetamide safeners (e.g., AD-67, benoxacor, dichlormid, and furilazole), naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl, 1-dichloroacetylhexahydro-3,3,8α-trimethylpyrrolo[1,2-α]pyrimidin-6-(2H-one), dichloromethyl-1,3-dioxolane, quinolinyloxyacetate compounds, or agriculturally acceptable salts, esters, or combinations thereof.

In an embodiment, the composition may be present in any agrochemically suitable form for storage and application to the ground. The compositions may be produced by mixing the actives in the composition with an inert carrier and adding surfactants and other adjuvants and carriers as needed and formulated into solid or liquid formulations, comprising wettable powders (WP), granules (GR), dusts, soluble (liquid) concentrates (SL), suspension concentrates (SC), oil in water emulsion (EW), water in oil emulsion (EO), emulsifiable concentrates (EC), capsule suspensions (CS), mixed formulation of CS and SC (ZC) formulations, oil dispersions (OD), other known formulation types, or combinations thereof. The composition may also be used for treatment of a plant propagation material, such as seeds, etc.

In an embodiment, the compositions of the present disclosure include both dilute compositions, which are ready for immediate use, and concentrated compositions, which require to be diluted before use, usually with water.

The herbicidal compositions of the present disclosure can be in any conventional agriculturally useful form, for example, in the form of a ready-to-use formulation, or in the form of a tank mix.

In an embodiment, the herbicidal actives may be formulated as a premix product or a ready-to-use product.

In an embodiment, the herbicidal actives may be tank-mixed at the time of application.

In an embodiment, the method comprises applying the present combinations or compositions simultaneously, that is jointly or separately, or in succession by burndown in absence of a crop.

In another embodiment, the constituents of the combination of the present disclosure may be tank mixed and applied or sprayed at the locus of the infection or may be alternatively mixed with surfactants and/or any other agrochemically acceptable excipients and then applied.

In yet another embodiment, the constituents of the combination of the present disclosure may be applied in such quick succession in any order to form the desired mix at the locus of application.

In an embodiment, the constituents of the composition of the present disclosure may be used for foliar application, ground or applications to plant propagation materials.

Each individual composition may comprise one or more agrochemically acceptable excipient/ingredients. The resulting combination or tank-mix of the composition comprising L-glufosinate, salts, esters, or combinations thereof and at least one additional herbicide provides a synergistic effect in controlling the weeds.

In accordance with another embodiment of the invention, there is provided a process for preparing a composition comprising L-glufosinate, salts, esters, or combinations thereof, and at least one additional herbicide. The said process further involves addition of an agrochemically acceptable excipient to the herbicidal actives. The resulting composition is storage stable with improved shelf-life.

According to another embodiment, there is provided use of a herbicidal composition for burndown application in absence of a crop, the composition comprising:
(a) L-glufosinate, salts, esters, or combinations thereof; and
(b) at least one agrochemically acceptable excipient.

According to another embodiment, there is provided use of a herbicidal combination for burndown application in absence of a crop, the combination comprising:
(a) L-glufosinate, salts, esters, or combinations thereof; and
(b) at least one additional herbicide; and

According to another embodiment, there is provided use of a herbicidal composition for controlling weeds at a locus thereof, by burndown in absence of a crop, the composition comprising:
(a) L-glufosinate, salts, esters, or combinations thereof;
(b) optionally at least one additional herbicide; and
(c) at least one agrochemically acceptable excipient.

According to another embodiment, there is provided use of a herbicidal composition for controlling weeds at a locus thereof, by burndown in absence of a crop, the composition comprising:
(a) L-glufosinate, salts, esters, or combinations thereof;
(b) at least one additional herbicide; and
(c) at least one agrochemically acceptable excipient.

According to another embodiment, there is provided use of a herbicidal composition comprising L-glufosinate, salts, esters, or combinations thereof and at least one agrochemically acceptable excipient to control, eradicate or prevent weed growth by burndown application in absence of a crop.

According to another embodiment, there is provided use of a herbicidal combination comprising L-glufosinate, salts, esters, or combinations thereof and at least one additional herbicide to control, eradicate or prevent weed growth by burndown application in absence of a crop.

According to another embodiment, there is provided use of a herbicidal composition comprising L-glufosinate, salts, esters, or combinations thereof and at least one agrochemically acceptable excipient to control, eradicate or prevent weed growth by burndown application in absence of a crop. In an embodiment, the composition further comprises at least one additional herbicide.

The herbicidal compositions of the present disclosure can be used in agricultural lands such as fields, paddy fields, lawns and orchards or in non-agricultural lands.

The present disclosure may be used to control diseases in agricultural lands for cultivating the plants without any phytotoxicity to the plant.

In an embodiment, the present disclosure provides use of a herbicidal composition for comprising L-glufosinate, salts, esters, or combinations thereof; at least one agrochemically acceptable excipient and at least one additional herbicide, for controlling undesirable vegetation in burndown programs, in absence of crops.

The compositions of the present disclosure are used to control undesired vegetation in various agricultural crops. Non-limiting examples of undesired vegetation controlled by the compositions of the present disclosure include:
Urticaceae weeds: Urtica urens;
Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa;
Portulacaceae weeds: Portulaca oleracea;
Caryophyllaceae weeds: Stellaria media, Cerastium holosteoides, Cerastium glomeratum, Spergula arvensis, Silene gallica;
Molluginaceae weeds: Mollugo verticillata;
Chenopodiaceae weeds: Chenopodium album, Chenopodium ambrosioides, Kochia scoparia, Salsola kali, Atriplex spp.;
Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella;
Papaveraceae weeds: Papaver rhoeas, Argemone Mexicana;
Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus;
Dinebra weeds: Dinebra americana, Dinebra aquatic, Dinebra aristidoides, Dinebra bromoides, Dinebra calycina, Dinebra caudata, Dinebra chinensis, Dinebra chloride, Dinebra chondrosioides, Dinebra coerulescens, Dinebra cristata, Dinebra curtipendula, Dinebra decipiens, Dinebra divaricate, Dinebra divaricatissima, Dinebra dura, Dinebra guineensis, Dinebra hirsute, Dinebra hirta, Dinebra juncifolia, Dinebra ligulata, Dinebra lima, Dinebra melicoides, Dinebra nealleyi, Dinebra neesii, Dinebra panicea, Dinebra panicoides, Dinebra pubescens, Dinebra repens, Dinebra scabra, Dinebra secunda, Dinebra simoniana, Dinebra southwoodii, Dinebra squarrosa, Dinebra srilankensis, Dinebra tuaensis, Dinebra verticillate, Dinebra retroflexa, Dinebra haareri, Dinebra marquisensis, Dinebra perrieri, Dinebra polycarpha, Dinebra somalensis, Capparaceae weeds: Cleome affinis;
Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis;
Oxalidaceae weeds: Oxalis corniculata, Oxalis strica, Oxalis oxyptera;
Geraniaceae weeds: Geranium carolinense, Erodium cicutarium;
Euphorbiaceae weeds: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis;
Malvaceae weeds: Corchorus, Abutilon theophrasti, Sida rhombiforia, Sida cordifolia, Sida spinosa, Sida glaziovii, Sida santaremnensis, Hibiscus trionum, Anoda cristata, Malvastrum coromandelianum.
Sterculiaceae weeds: Waltheria indica;
Violaceae weeds: Viola arvensis, Viola tricolor;
Cucurbitaceae weeds: Sicyos angulatus, Echinocystis lobata, Momordica charantia;
Lythraceae weeds: Lythrum salicaria;
Apiaceae weeds: Hydrocotyle sibthorpioides;
Sapindaceae weeds: Cardiospermum halicacabum;
Primulaceae weeds: Anagallis arvensis;
Asclepiadaceae weeds: Asclepias syriaca, Ampelamus albidus;
Rubiaceae weeds: Galium aparine, Galium spurium var. echinospermon, Spermacoce latifolia, Richardia brasiliensis, Borreria alata, Borreria verticilata;
Convolvulaceae weeds: Ipomoea alba, Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia;
Boraginaceae weeds: Myosotis arvensis;
Lamiaceae weeds: Lamium purpureum, Lamium amplexicaule, Leonotis nepetaefolia, Hyptis suaveolens, Hyptis lophanta, Leonurus sibiricus, Stachys arvensis;
Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides;
Scrophulariaceae weeds: Veronica hederaefolia, Veronica persica, Veronica arvensis;
Plantaginaceae weeds: Plantago asiatica;
Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis;
Liliaceae weeds: Allium canadense, Allium vineale;
Commelinaceae weeds: Cyanotis axillaris, Commelina communis, Commelina benghalensis, Commelina erecta;
Poaceae weeds: Dinebra retroflexa, Cynodon dactylon, Echinochloa colonum, Echinochloa crusgalli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spicaventi, Panicum dichotomiflorum, Panicum texanum, Panicum maximum, Brachiaria reptains Brachiaria platyphylla, Brachiaria ruziziensis, Brachiaria plantaginea, Brachiaria decumbens, Brachiaria brizantha, Brachiaria humidicola, Brachiaria mutica, Cenchrus echinatus, Cenchrus pauciflorus, Eriochloa villosa, Pennisetum setosum, Chloris gayana, Chloris barbata, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis;
Cyperaceae weeds: Cyperus microiria, Cyperus iria, Cyperus odoratus, Cyperus rotundus, Cyperus esculentus, Kyllinga gracillima,
Equisetaceae weeds: Equisetum arvense, Equisetum palustre;
Trianthema weeds, and the like.

In an embodiment, the undesirable vegetation in burndown is weedy Glycine max.

In an embodiment, the undesirable vegetation in burndown is Eleusine indica.

In an embodiment, the undesirable vegetation in burndown is Spermacoce latifolia.

In an embodiment, the undesirable vegetation in burndown is Brachiaria decumbens or Congo grass.

In an embodiment, the undesirable vegetation in burndown is Amaranthus hybridus and Amaranthus viridis.

In an embodiment, the undesirable vegetation in burndown is Borreria verticillata.

In an embodiment, the undesirable vegetation in burndown is Euphorbia heterophylla.

In an embodiment, the undesirable vegetation in burndown is Bidens Pilosa.

In a preferred embodiment, the herbicidal composition is used to control broadleaf and grassy weeds, wherein the weeds are selected from the group comprising Amaranthus viridis, Amaranthus spinosus, Acalypha indica, Brachiaria spp., C. Album, Digera arvensis, Dinebra retroflexa, Echonochloa colonum, Euphorbia geniculate, Portulaca oleracea, Parthenium hysterophrous, Phyllanthus maderaspatensis, or combinations thereof.

In another embodiment, the herbicidal composition is applied for preplant burndown to control from about 70% to about 100% of the weeds.

According to another embodiment, there is provided a method for controlling weeds at a locus thereof by burndown in absence of a crop, the method comprising applying at a locus thereof, an effective amount of a herbicidal composition comprising:
(a) L-glufosinate, salts, esters, or combinations thereof; and
(b) at least one agrochemically acceptable excipient.

In another embodiment, the herbicidal composition further comprises at least one additional herbicide.

According to another embodiment, there is provided a method for controlling weeds in burndown application in absence of a crop, by a herbicidal combination comprising:
(a) L-glufosinate, salts, esters, or combinations thereof; and
(b) at least one additional herbicide; and According to another embodiment, there is provided a method for controlling weeds in burndown application in absence of a crop, by a herbicidal composition comprising:
(a) L-glufosinate, salts, esters, or combinations thereof;
(b) at least one additional herbicide; and
(c) at least one agrochemically acceptable excipient.

According to another embodiment, there is provided a method for using a herbicidal composition comprising L-glufosinate, salts, esters, or combinations thereof and at least one agrochemically acceptable excipient to control, eradicate or prevent weed growth by burndown application in absence of a crop.

According to another embodiment, there is provided a method for using a herbicidal combination comprising L-glufosinate, salts, esters, or combinations thereof and at least one additional herbicide to control, eradicate or prevent weed growth by burndown application in absence of a crop.

According to another embodiment, there is provided a method for using a herbicidal composition comprising L-glufosinate, salts, esters, or combinations thereof and at least one agrochemically acceptable excipient to control, eradicate or prevent weed growth by burndown application in absence of a crop. In an embodiment, the composition further comprises at least one additional herbicide.

In another embodiment, the method for controlling undesirable vegetation in burndown programs, in absence of a crop, comprises L-glufosinate, salts, esters, or combinations thereof and at least one additional herbicide.

In another embodiment, the method for controlling weeds at a locus thereof, by burndown in absence of a crop, the method comprising applying to the locus, an effective amount of L-glufosinate, salts, esters, or combinations thereof.

According to an embodiment, the weeds targeted by the combinations and compositions of the present invention are grassy weeds and broadleaf weeds.

It was surprisingly found that the combinations of the present invention were effective and showed synergistic control over resistant varieties of weeds.

In an embodiment, the combinations or the compositions according to the present invention may be used for burndown application or fallow application in absence of any crop.

In an embodiment, the weed removal is not restricted to crop land or agricultural land only. The weeds are targeted in non-agricultural areas such as, but not limited to, forestries, railways, infrastructure, amenities, companies, factories, roads and runways, sidewalks, highways, dividers, medians, pipelines, public utility lines, pumping stations, transformer stations, substations, around airports, electric utilities, commercial buildings, manufacturing plants, storage yards, rail yards, hangars, fence lines, parking lots, parkways, sedges, post-harvest crop lands, beneath greenhouse benches and around golf courses.

According to an embodiment, there is provided a method of application of a combination or a composition comprising L-glufosinate, salts, esters, or combinations thereof, and at least one additional herbicide, for control, eradication or prevention of weed growth by burndown application in absence of a crop.

The combination of the present invention maybe applied simultaneously as a tank mix or a premix formulation or may be applied sequentially. The application may be made to the soil before emergence of the plants. The application may be made as a foliar spray at different timings. Herbicidal compositions according to the disclosure can also be incorporated into the soil before sowing seeds of a crop. These combinations as described above may be applied to the locus of the weeds, in an herbicidally effective amount.

In an embodiment, L-glufosinate, salts, esters, or combinations thereof is applied to a target locus at a rate of about 1 to 3000 g a.i./ha. In an embodiment, L-glufosinate, salts, esters, or combinations thereof is applied to a target locus at a rate of about 1 to 2000 g a.i./ha. In an embodiment, L-glufosinate, salts, esters, or combinations thereof is applied to a target locus at a rate of about 1 to 1000 g a.i./ha. In an embodiment, L-glufosinate, salts, esters, or combinations thereof is applied to a target locus at a rate of about 1 to 500 g a.i./ha. In an embodiment, L-glufosinate, salts, esters, or combinations thereof is applied to a target locus at a rate of about 100 to 500 g a.i./ha. In an embodiment, L-glufosinate, salts, esters, or combinations thereof is applied to a target locus at a rate of about 100 to 300 g a.i./ha.

In an embodiment, L-glufosinate is applied to a target locus at a rate of about 495 g a.i./ha. In an embodiment, L-glufosinate is applied to a target locus at a rate of about 280 g a.i./ha. In an embodiment, L-glufosinate is applied to a target locus at a rate of about 220 g a.i./ha. In an embodiment, L-glufosinate is applied to a target locus at a rate of about 200 g a.i./ha. In an embodiment, L-glufosinate is applied to a target locus at a rate of about 165 g a.i./ha. In an embodiment, L-glufosinate is applied to a target locus at a rate of about 150 g a.i./ha.

In an embodiment, the method of controlling undesirable vegetation in burndown program in absence of a crop, comprises applying at a locus L-glufosinate, salts, esters, or combinations thereof and in combination with at least one additional herbicide, wherein L-glufosinate, salts, esters, or combinations thereof is applied at an application rate of about 1 to 3000 g a.i./ha.

In an embodiment, the method of controlling undesirable vegetation in burndown program in absence of a crop, comprises applying at a locus L-glufosinate, salts, esters, or combinations thereof or in combination with at least one additional herbicide, wherein L-glufosinate, salts, esters, or combinations thereof is applied at an application rate of about 100 to 250 g a.i./ha.

In an embodiment, the method of controlling undesirable vegetation in burndown program in absence of a crop, comprises applying at a locus L-glufosinate, salts, esters, or combinations thereof or in combination with at least one additional herbicide, wherein L-glufosinate, salts, esters, or combinations thereof is applied at an application rate of about 1 to 250 g a.i./ha.

In an embodiment, the herbicide composition or combinations and methods disclosed herein can be used to control undesired vegetation in absence of crops, particularly in burndown programs. In some embodiments, the compositions and methods disclosed herein can be used for controlling undesired vegetation before planting a crop. Examples of the crops which may be planted after the compositions according to the present disclosure has been used for burndown application include, but are not limited to, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., Asteraceae vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, Colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the method comprises applying the present compositions comprising L-glufosinate, salts, esters, or combinations thereof or in combination with at least one additional herbicide simultaneously, that is jointly or separately, or in succession.

In an embodiment, the method comprises applying the present compositions before planting a crop.

In an embodiment, the method comprises applying in immediate succession the combination of L-glufosinate, salts, esters, or combinations thereof and at least one additional herbicide.

The compositions of the present disclosure may be applied in any known ways or conventional methods known to a person skilled in art. Non limiting examples of such methods are foliar spray, basal barking, stem injection, drill and fill method, axe cut method, cut stump, cut and swab, stem scraper, wick application and so forth. The compositions of the present disclosure are used in the customary manner, for example by watering, spraying, atomizing, dusting or scattering. Said compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

In an embodiment, the present disclosure provides a method of increasing yield in a crop by burndown application of present herbicidal compositions/combinations comprising L-glufosinate, salts, esters, or combinations thereof as described herein.

In an embodiment, the present disclosure provides a method of improving the plant health by burndown application of present herbicidal composition/combinations comprising L-glufosinate, salts, esters, or combinations thereof as described herein.

The burndown herbicidal composition/combinations of the present disclosure are highly safe to crop plants and capable of controlling problematic unwanted vegetation in agriculture or non-agricultural fields.

Typically, for the product of the present invention, the composition is applied at a rate that is ranging from 1 to 1000 kg/ha. Yet, the weight ratios of individual components can be varied within relatively wide ranges. Typically, there are 1:1000 to 1000:1 part by weight of the active compounds.

The combinations of the present invention may be developed as a pre-mix composition or a kit of parts such that individual actives may be mixed before applying.

Thus, an embodiment of the present invention provides a kit-of-parts comprising a first component of L-glufosinate, salts, esters, or combinations thereof and a second component of at least one additional herbicide. In an embodiment, one of the two components or both may be admixed with at least one or more agrochemically acceptable excipients. The kit of parts may contain either the L-glufosinate herbicide or a salt thereof and at least one additional herbicide previously admixed, individually or together, with an adjuvant or an agrochemically acceptable excipient such that the two components may be tank mixed before applying. The kit-of-parts may be further accompanied by a set of instructions in form of a manual, guide, booklet, pamphlet, and so forth.

According to an embodiment, the kit of parts comprises:
(a) L-glufosinate, salts, esters, or combinations thereof; and
(b) at least one agrochemically acceptable excipient;
and optionally further comprises:
(c) instructions for use.

According to an embodiment, the kit of parts comprises:
(a) L-glufosinate, salts, esters, or combinations thereof;
(b) at least one additional herbicide; and
(c) at least one agrochemically acceptable excipient;
and optionally further comprises:
(d) instructions for use.

These combinations or compositions as described above may be applied to the weed or to locus of the weeds or to the plant/crop, in synergistically effective amount. It can be seen from the use examples herein below that the found herbicidal action of the active compound combinations according to the invention exceeds the calculated value, that is to say that the new active compound combinations have a synergistic effect in controlling weeds.

Specifically, the invention includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein. A number of embodiments of the invention have been described. Nevertheless, it will be understood that various modifications may be made without departing from the spirit and scope of the invention.

These and other advantages of the invention may become more apparent from the examples set forth. These examples are provided merely as illustrations of the invention and are not intended to be construed as a limitation thereof.

Specifically, the invention includes embodiments in which a particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein.

### EXAMPLES

Herbicidal compositions comprising active ingredients such as L-glufosinate, salts, esters, or combinations thereof were used in the present invention for burndown applications for controlling weeds/unwanted vegetation in non-crop fields, i.e., in absence of any crops.

### Evaluation of Herbicidal Activity:

Methodology: Greenhouse trials were conducted to evaluate the efficacy of the L-glufosinate on broad spectrum weeds at non-crop stage (burndown application).

The soil used was medium black soil. All treatments were in 3 replications per treatment with a spray volume of about 150 L/ha.

### Example 1: Efficacy of L-Glufosinate for Burndown Application

Table 1 demonstrates efficacy of L-glufosinate (SL) for burndown application. The percentage efficacy was calculated after 10 days of application (DAA). The target weeds were Amaranthus viridis, E. geniculate, P. oleracea, Brachiaria spp. and the concentration of the herbicide and the results are recorded in Table 1.

| | Application | % Control after 10 DAA | | |
|---|---|---|---|---|
| Active ingredient, | Rate | Amaranthus | E. | Brachiaria |
| (g a.i./L) | (g a.i./ha) | viridis | geniculate | spp. |
| L-glufosinate, 280 | 150 | 100 | 92 | 100 |
| L-glufosinate, 280 | 165 | 100 | 90 | 100 |
| L-glufosinate, 280 | 200 | 100 | 95 | 100 |
| L-glufosinate, 280 | 220 | 100 | 93 | 100 |
| L-glufosinate, 200 | 150 | 100 | 93 | 100 |
| L-glufosinate, 200 | 165 | 100 | 95 | 100 |
| L-glufosinate, 200 | 200 | 100 | 97 | 100 |
| L-glufosinate, 200 | 220 | 100 | 93 | 100 |

Therefore, control of different weeds by burndown application (in absence of crops) of herbicidal composition comprising L-glufosinate was observed.

### Example 2: Efficacy of L-Glufosinate for Burndown Application

Table 2 demonstrates efficacy of L-glufosinate for burndown application in absence of crops. The percentage efficacy was calculated after 10 and 15 days of application (DAA). The herbicidal composition used was L-glufosinate (SL) at 150 g a.i./L. The application rate was 495 g a.i./ha. The target weeds were Amaranthus virids, A. spinosus, C. Album, E. geniculate, P. oleracea, P. hysterophrous, Brachiaria spp., D. retroflexa, E. colonum and the concentration of the herbicide and the results are recorded in Table 2.

% Control by L-glufosinate (SL)
Dose - 150 g a.i./L;
Application rate - 495 g a.i./ha

| Weed(s) | 10 DAA | 15 DAA |
|---|---|---|
| Amaranthus viridis | 100 | 100 |
| A. spinosus | 100 | 100 |
| C. Album | 100 | 100 |
| E. geniculate | 100 | 100 |
| P. oleracea | 88 | 82 |
| P. hysterophrous | 100 | 100 |
| Brachiaria spp. | 93 | 100 |
| D. retroflexa | 100 | 100 |
| E. colonum | 90 | 90 |

Therefore, control of different weeds by burndown application (in absence of crops) of herbicidal composition comprising L-glufosinate was observed.

### Example 3: Efficacy of L-Glufosinate for Burndown Application for Broadleaf Weeds

Table 3 demonstrates efficacy of L-glufosinate for burndown application in absence of crops. The percentage efficacy was calculated after 10 and 15 days of application (DAA). The herbicidal composition used was L-glufosinate (SL) at 150 g a.i./L and 280 g a.i./L. The application rate was 495 g a.i./ha. The target weeds were Amaranthus viridis, Amaranthus spinosus, Acalypha indica, Digera arvensis, Euphorbia geniculate, Portulaca oleracea, Parthenium hysterophrous, Phyllanthus maderaspatensis and the concentration of the herbicide and the results are recorded in Table 3.

| | % Control | | | |
|---|---|---|---|---|
| | L-glufosinate (SL) | | L-glufosinate (SL) | |
| | 150 g a.i./L | | 280 g a.i./L | |
| Weed(s) | 10 DAA | 15 DAA | 10 DAA | 15 DAA |
| Amaranthus | 100 | 100 | 100 | 100 |
| viridis | | | | |
| Amaranthus | 100 | 100 | 100 | 100 |
| spinosus | | | | |
| Acalypha indica | 80 | 100 | 87 | 100 |
| Digera arvensis | 100 | 100 | 100 | 100 |
| Euphorbia | 80 | 100 | 90 | 100 |
| geniculate | | | | |
| Portulaca | 100 | 100 | 100 | 100 |
| oleracea | | | | |
| Parthenium | 93 | 93 | 97 | 97 |
| hysterophrous | | | | |
| Phyllanthus | 93 | 100 | 97 | 97 |
| maderaspatensis | | | | |

Therefore, control of different broadleaf weeds by burndown application (in absence of crops) of herbicidal composition comprising L-glufosinate was observed.

### Example 4: Efficacy of L-Glufosinate for Burndown Application for Grass Weeds

Table 4 demonstrates efficacy of L-glufosinate for burndown application in absence of crops. The percentage efficacy was calculated after 10 and 15 days of application (DAA). The herbicidal composition used was L-glufosinate (SL) at 150 g a.i./L and 280 g a.i./L. The application rate was 495 g a.i./ha. The target weeds were Brachiaria spp., Dinebra retroflexa, Echonochloa colonum and the concentration of the herbicide and the results are recorded in Table 4.

| | % Control | | | |
|---|---|---|---|---|
| | L-glufosinate (SL) | | L-glufosinate (SL) | |
| | 150 g a.i./L | | 280 g a.i./L | |
| Weed(s) | 10 DAA | 15 DAA | 10 DAA | 15 DAA |
| Brachiaria spp. | 100 | 100 | 100 | 100 |
| Dinebra | 83 | 70 | 83 | 70 |
| retroflexa | | | | |

Therefore, control of different grass weeds by burndown application (in absence of crops) of herbicidal composition comprising L-glufosinate was observed.

1. A method for controlling weeds at a locus thereof, by burndown in absence of a crop, the method comprising applying to the locus, an effective amount of a herbicidal composition comprising:
(a) L-glufosinate, salts, esters, or combinations thereof; and
(b) at least one agrochemically acceptable excipient thereof.

2. The method as claimed in claim 1, wherein the salt comprises an inorganic salt of L-glufosinate.

3. The method as claimed in claim 2, wherein the inorganic salt of L-glufosinate is selected from the group consisting of L-glufosinate ammonium, L-glufosinate sodium, L-glufosinate potassium, and combinations thereof.

4. The method as claimed in claim 1, wherein the herbicidal composition further comprises at least one additional herbicide.

5. The method as claimed in claim 1, wherein the L-glufosinate, salts, esters, or combinations thereof is present in an amount from about 100 g a.i./L to about 400 g a.i./L.

6. The method as claimed in claim 1, wherein the L-glufosinate, salts, esters, or combinations thereof is applied at an application rate from about 100 g a.i./ha to about 500 g a.i./ha.

7. The method as claimed in claim 1, wherein the herbicidal composition is applied for preplant burndown to control from about 70% to about 100% of the weeds.

8. The method as claimed in claim 1, wherein the weeds in burndown comprise broadleaf and grassy weeds.

9. The method as claimed in claim 8, wherein the broadleaf and grassy weeds are selected from the group consisting of Amaranthus viridis, Amaranthus spinosus, Acalypha indica, Brachiaria spp., C. Album, Digera arvensis, Dinebra retroflexa, Echonochloa colonum, Euphorbia geniculate, Portulaca oleracea, Parthenium hysterophrous, Phyllanthus maderaspatensis, and combinations thereof.

10. A method for controlling weeds at a locus thereof, by burndown in absence of a crop, the method comprising applying to the locus, an effective amount of L-glufosinate, salts, esters, or combinations thereof.

11. A herbicidal combination for controlling weeds at a locus thereof, by burndown in absence of a crop, the combination comprising:
(a) L-glufosinate, salts, esters, or combinations thereof; and
(b) at least one additional herbicide.

12. A herbicidal composition for controlling weeds at a locus thereof, by burndown in absence of a crop, the composition comprising:
(a) L-glufosinate, salts, esters, or combinations thereof; and
(b) at least one agrochemically acceptable excipient.

13. The composition as claimed in claim 12, wherein the composition further comprises at least one additional herbicide.

14. (canceled)
